(19) United States
(12) Patent Application Publication
(10) Pub. No.: US 2018/0060320 A1
(43) Pub. Date: Mar. 1, 2018

(54) INTERACTIVE MULTIPLE USER PLAYLIST SHARING

(71) Applicant: Arkadii Oganian, Adeje (ES)

(72) Inventor: Arkadii Oganian, Adeje (ES)

(21) Appl. No.: 15/687,312

(22) Filed: Aug. 25, 2017

Related U.S. Application Data
(60) Provisional application No. 62/380,142, filed on Aug. 26, 2016.

(51) Int. Cl. G06F 17/30; G06F 3/0482; G06Q 20/40; G06Q 20/12

(52) U.S. Cl. CPC G06F 17/30038; G06F 3/0482; G06F 17/30053; G10H 2240/131; G06Q 20/403; G06Q 20/123; G06F 17/30165

(57) ABSTRACT

A system and method for providing multiple user access to a playlist is described. A master user device and a guest user device are connected to the same network. A guest user device may search for playlists available in the network, and select one of the available playlists that is created by a master user. The guest user may then modify the selected playlist by adding a media file to the playlist and selecting a position in which the media file is to be output in the playlist. The guest user device may add the media file to the playlist by sending a cloud link to the master user device. The media file to be added to the playlist must satisfy one or more rules associated with an eligibility criteria before the media file can be added to the playlist.

### CROSS-REFERENCE TO RELATED APPLICATION

This application claims priority from and the benefit of U.S. Provisional Application No. 62/380,142, filed on Aug. 26, 2016, which is incorporated by reference herein.

### FIELD

This disclosure generally relates to creating and sharing media playlists.

### BACKGROUND

Playlists for outputting media files, such as music, image, or video files, enable a user to output the media files in a preferred or random order. However, playlists are often limited to a particular device or user and cannot readily be accessed by multiple users or devices.

### SUMMARY

This disclosure generally describes a system and method for customizing and sharing a playlist across a network for multiple users.

Innovative aspects of the subject matter described in this specification may, in some implementations, be embodied in a computer-implemented method that includes actions of receiving a request to access a playlist created by a first user device from a second user device. The first user device and the second user device are connected to the same wireless network. The actions also include providing, to the second user device, (i) access to the playlist created by the first user device, and (ii) an indication of a subscription status of a user associated with the first user device with a media provision service. The actions also include receiving, from the second user device, an indication of a media file to be added to the playlist, determining, by one or more processors, metadata associated with the media file to be added to the playlist based on the indication of the media file, transmitting a query for the media file to a cloud database that supports the media provision service using portions of the metadata associated with the media file, obtaining, from the cloud database, the media file, and adding the media file to the playlist.

Other implementations of these aspects include corresponding systems, apparatus, computer-readable storage mediums, and computer programs configured to implement the actions of the above-noted method.

These and other implementations may each optionally include one or more of the following features. For instance, in some implementations, the operations further include receiving a request to create the playlist from the first user device, and in response to the request to create the playlist, providing, to the first user device, data to generate and populate the playlist on the first user device.

In some implementations, the operations further include receiving one or more playlist setting parameters to configure the playlist. The one or more playlist setting parameters include a number of users permitted to contribute to the playlist, a type and a number of media files in the playlist, a number of media files that are provided from one user and are listed consecutively in the playlist, a number of times the same media file is repeated in the playlist, a size limit on media files in the playlist, a time limit for playback of a media file in the playlist, and a type of network the playlist is provided through.

In some implementations, the operation of providing, to the second user device, access to the playlist created by the first user device includes operations of determining whether a user associated with the second user device is authorized to join the playlist as a playlist contributor in response to receiving the request to access the playlist created by the first user device from the second user device, determining that the second user device is authorized to join the playlist as a playlist contributor, and transmitting, to the second user device, a message indicating that the user associated with the second user device is authorized to join the playlist as a playlist contributor.

In some implementations, the operations further include receiving, from the second user device, a query for one or more playlists available on the network, determining one or more network addresses of one or more network devices, respectively, and one or more playlists provided by the one or more network devices, and transmitting, to the second user device, data indicative of the one or more playlists available on the network. The data indicative of the one or more playlists available on the network includes data indicative of the determined one or more playlists provided by the one or more network devices. The operations further include receiving, from the second user device, a selection of one of the one or more playlists available on the network, the selected playlist corresponding to the playlist created by the first user device.

In some implementations, the metadata associated with the media file to be added to the playlist is determined when the user associated with the first user device is subscribed with the media provision service.

In some implementations, in response to receiving the indication of the media file to be added to the playlist from the second user device, the media file is determined to satisfy a criteria for being added to the playlist. The criteria includes one or more of a size of the media file, a playback time of the media file, a theme associated with the playlist, a threshold for a number of media files that are provided from the second user device and listed consecutively in the playlist, and a number of times the media file is repeated in the playlist.

In some implementations, the operations further include receiving, from the second user device, a request to modify a position of the added file in the playlist created by the first user device, accessing a user profile of a user associated with the second user device, determining, from data stored in the user profile of the user associated with the second user device, a currency amount allocated to the user associated with the second user device, and determining whether the currency amount allocated to the user associated with the second user device satisfies a currency threshold for modifying the position of the added file.

In some implementations, in response to determining that the currency amount allocated to the user associated with the second user device satisfies the currency threshold for modifying the position of the added file, the position of the added file is modified to a position indicated in the request to modify the position of the added file. In response to determining that the currency amount allocated to the user associated with the second user device does not satisfy the currency threshold for modifying the position of the added file, a message indicating that the position of the added file has not been modified is transmitted to the second user device.

In some implementations, the operations further include receiving, from the second user device, a request to delete the added file from the playlist created by the first user device, and removing the added file from the playlist created by the first user device.

In some implementations, for each user device having access to the playlist, the operations further include generating a graphical indicator for the user device, and providing the graphical indicator to the user device. The graphical indicator is displayed on the user device with a name of a file added by the user device to the playlist. A selection to modify a position of the file added by the user device is received through the graphical indicator.

The details of one or more implementations are set forth in the accompanying drawings and the description below. Other features and advantages will become apparent from the description, the drawings, and the claims.

### BRIEF DESCRIPTION OF THE DRAWINGS

FIG. 1 depicts a portion of the method for sharing a playlist between multiple users according to exemplary implementations.

FIG. 2 depicts a portion of the method for sharing a playlist between multiple users according to exemplary implementations.

FIG. 3 depicts a portion of the method for sharing a playlist between multiple users according to exemplary implementations.

FIG. 4 depicts a portion of the method for sharing a playlist between multiple users according to exemplary implementations.

FIG. 5 depicts a portion of the method for sharing a playlist between multiple users according to exemplary implementations.

FIG. 6 depicts a portion of the method for sharing a playlist between multiple users according to exemplary implementations.

FIG. 7 depicts a portion of the method for sharing a playlist between multiple users according to exemplary implementations.

FIG. 8 depicts a portion of the method for sharing a playlist between multiple users according to exemplary implementations.

FIG. 9 depicts a portion of the method for sharing a playlist between multiple users according to exemplary implementations.

FIG. 10 depicts a portion of the method for sharing a playlist between multiple users according to exemplary implementations.

FIG. 11 depicts a portion of the method for sharing a playlist between multiple users according to exemplary implementations.

FIG. 12 depicts a portion of the method for sharing a playlist between multiple users according to exemplary implementations.

FIG. 13 depicts a portion of the method for sharing a playlist between multiple users according to exemplary implementations.

FIG. 14 depicts a portion of the method for sharing a playlist between multiple users according to exemplary implementations.

FIG. 15 depicts a portion of the method for sharing a playlist between multiple users according to exemplary implementations.

FIG. 16 depicts a system that implements a playlist sharing method.

### DETAILED DESCRIPTION

This disclosure generally describes a system and method for customizing and sharing a playlist across a network for multiple users. A user, using an electronic device, may connect to a WiFi network through a router or may establish a wireless hotspot. The user may then compile a media playlist by, for example, importing files from a media library, and may designate the user device as the master device of the playlist. A guest user may connect the guest user's electronic device to the WiFi network or wireless hotspot created by the master user, and search for playlists available in the WiFi network. After receiving information indicative of the available playlists on the WiFi network, the guest user may select one of the available playlists. The guest user may then modify the selected playlist by, for example, adding a media file to the playlist and selecting a position at which the media file is to be output in the playlist. The media file selected by the guest user to be added to the playlist may be evaluated to determine if the media file satisfies one or more rules associated with an eligibility criteria before the media file can be added to the playlist. In some cases, the media file may be added to the playlist by sending a cloud link associated with the media file from the guest user device to the master user's electronic device. The master user's device accesses an online media database or library to download the media file using the cloud link sent by the guest user. In some cases, the guest user may perform a peer-to-peer transfer and send the master user's device the media file to be added to the playlist.

According to implementations, a master user may refer to a user who initiates or creates a playlist. The master user may operate a master device, which may be any suitable electronic device. Examples of an electronic device include, but are not limited to, a computer, lap top, personal digital assistant, electronic pad, electronic notebook, telephone, smart phone, television, smart television, a watch, smart glasses, or any electronic device that is connected to a network and has a display. A master device may be any combination of hardware and software and may execute any suitable operating system. The master device includes an application for sharing playlists with other users in a network.

Additional users that want to share or access the playlist created by the master user may be referred to as guest users. Guest users may operate a guest device, which may be any suitable electronic device other than the master device. A guest device may be any combination of hardware and software and may execute any suitable operating system. Each of the guest devices may include an application for sharing playlists with other users in a network.

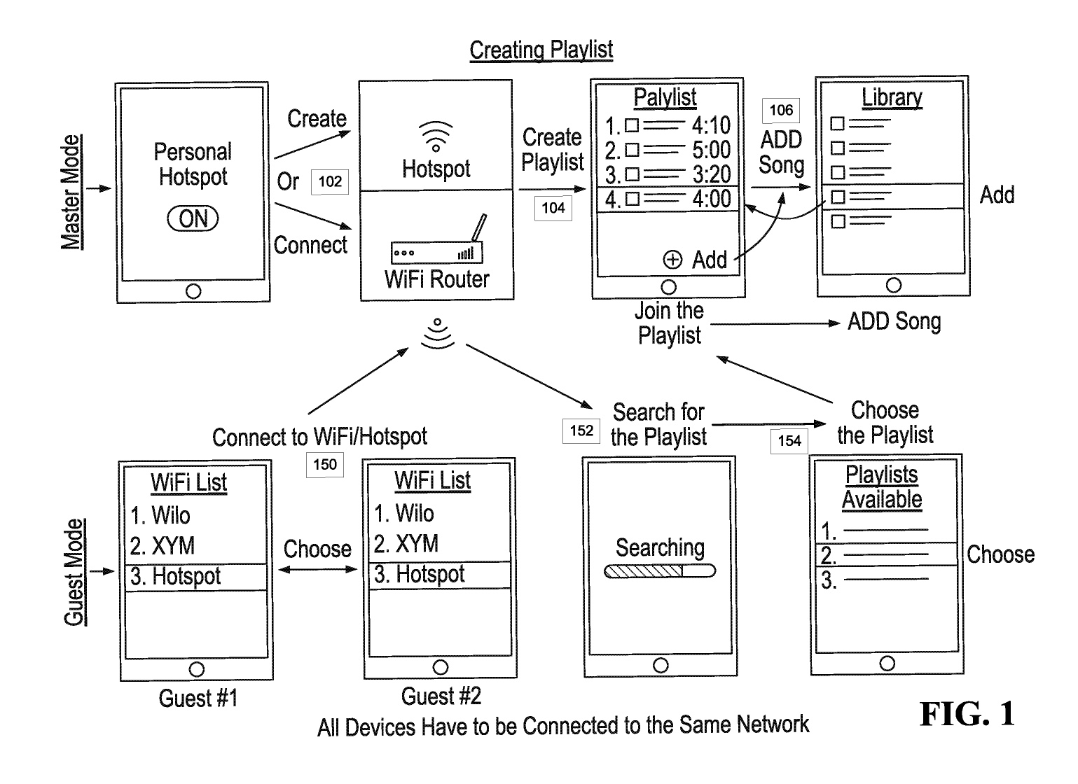

Referring to FIG. 1, to create and share a playlist between multiple users, a master user may connect the master device to a wireless network (102). For example, if not already connected to a network, in some cases, the master user may connect the master device to a network through a network device, such as a router. The master user may, for example, select a WiFi network to join from a list of available WiFi networks. In some cases, the master user may select a hotspot functionality on the master device to establish the master device as a hotspot that is connected to a network. In some cases, the master device may connect to a guest device that is operating as a hotspot.

When the master device is connected to a network, the master device may receive an input from the master user indicating that the master user would like to create a playlist (104). The master device may then activate a playlist sharing application in response to the input, display a setup screen, and receive one or more inputs from the master user to generate a playlist. The one or more inputs may be received through any suitable user interface, such as a Graphical User Interface (GUI), a touch screen, a key board, or microphones for receiving audio signals. Various suitable settings may be applied for a playlist including, for example, a name of the playlist, a number of users that can contribute to the playlist, an image associated with the playlist, a type and a number of media files that can be added to the playlist, a size limit of a media file that can be added to the playlist, a time limit for playback of a media file that can be added to the playlist, a number of media files that can be provided from one user and are listed consecutively in the playlist, a number of times the same media file is repeated in the playlist, a password for joining the playlist as a contributor or to share the playlist, and a type of network the playlist is available on.

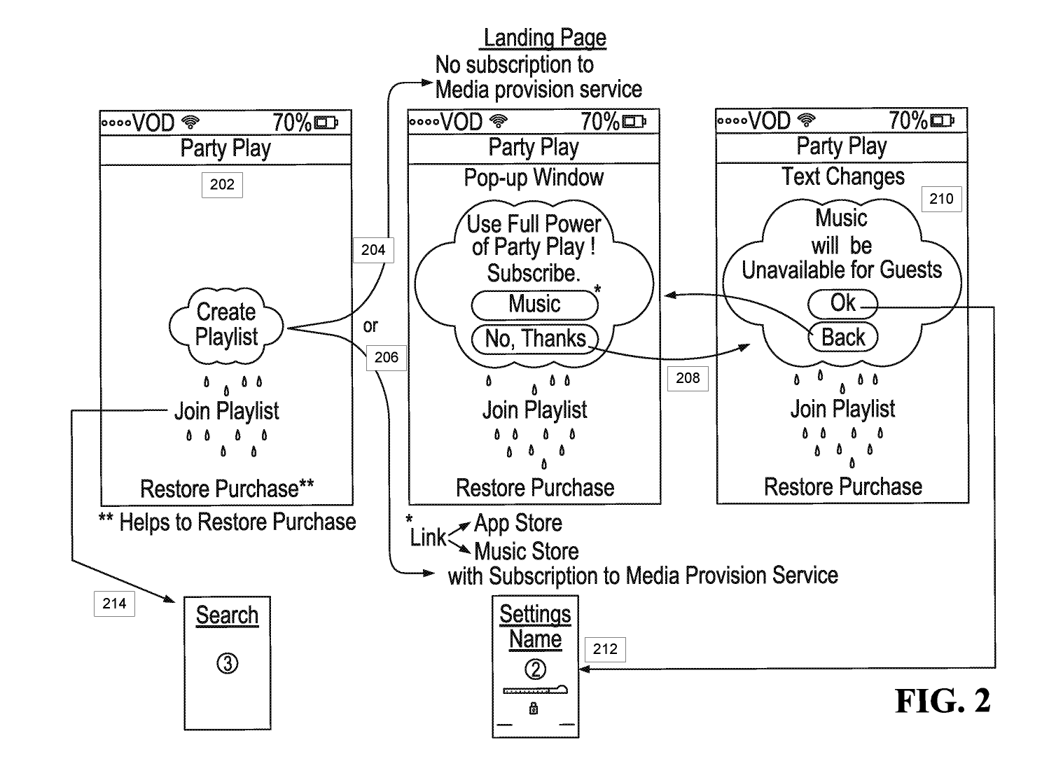

For example, as shown in FIG. 2, after the master device connects to a network, the master device may display a playlist selection interface through which the master user is presented with options to create a playlist or join a playlist (202). If the master user selects an option to create a playlist, the master device may determine whether the master user has a subscription to a media provision service, such as for example, an application store or an online or cloud database that is authorized to provide media files for download, output, or streaming.

If the master user does not have an existing subscription to a media provision service, the master device may open a locally accessible media library such as a library of media files stored on the master device or server to which the master device has authorized access to (204). The master device may then display a representation of the media library, and the master user may select one or more files to add to the playlist.

In some implementations, the master device may also display a message querying the master user for the master user's interest in subscribing to one or more media provision services. If the master user makes a selection indicating an interest to subscribe to one or more media provision services, the master user may then search the Internet for web links through which the master user can subscribe to the one or more media provision services. The web links can be displayed to the master user for selection.

If the master user does have an existing subscription to a media provision service, the master device may query the user as to whether the master user would like to use the subscription service (206). If the master user elects to use the subscription service, the master device may receive data from a server of the media provision service that includes one or more media files that the master user is authorized to access through the subscription service. If the master user elects not to use the subscription service (208), the master device may display a message indicating that the media provision service will be unavailable to the master user and any other user who joins the playlist (210). The playlist settings are updated to reflect the prohibited access to the media provision service for other users who join the playlist in future (212).

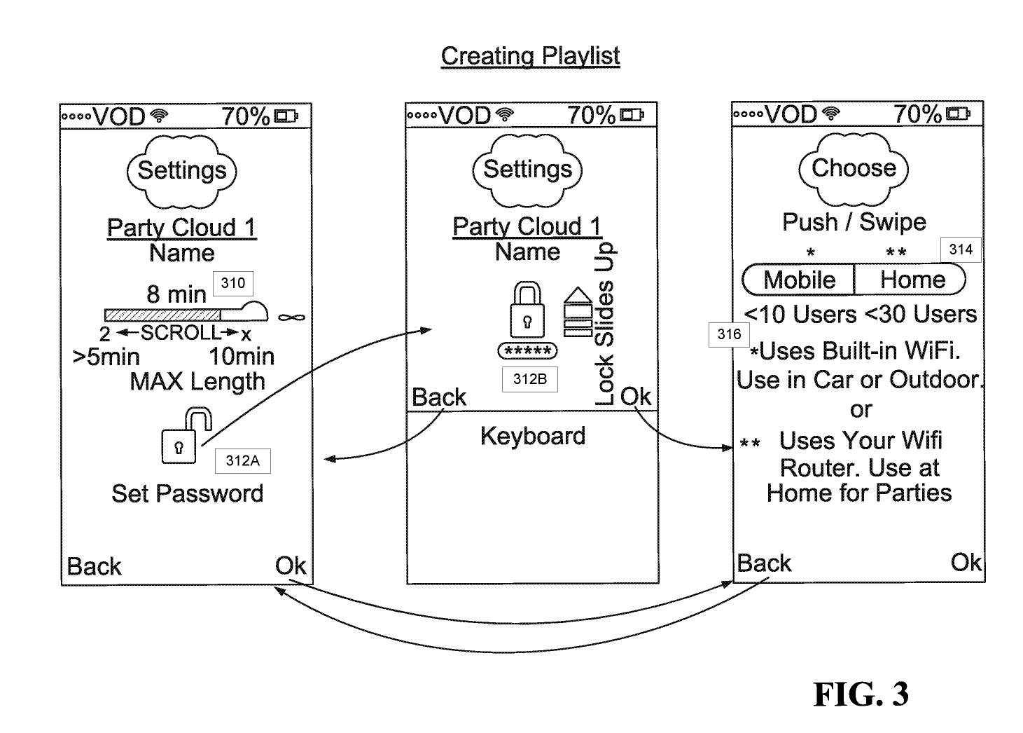

In some implementations, the playlist may be generated using default settings and without receiving any settings input from the master user. In some implementations, a playlist is generated after receiving setting data from the master user. The settings may be modified at any time the playlist sharing application is being executed. As shown in FIG. 3, the master device may receive inputs from the master user that specify a name of the playlist, a maximum length of a media file in time or size (310), a password for the playlist (312A, 312B), a type of connection to associate with the playlist (314), and a maximum number of users authorized to be guests sharing the playlist (316). For example, the master user may enter a name “Party Cloud 1” as the playlist name, select a “Set Password” option (312A), and enter the password for the playlist (312B) when requested to do so by the master device. After receiving the password, the master device may store the password and associate it with the playlist.

In some implementations, the master user may also provide a selection of a wireless connection type, for example, a Home or Mobile connection (314). A Home connection may limit playlist guests to guests who are connected to local networks such as WiFi or Bluetooth networks. A Mobile connection may limit guests to guests who are connected to wide area networks such as cellular networks. In some implementations, local connection types, such as a Home connection, may be configured to allow a greater number of users simultaneously sharing the playlist compared to the number of users in wide area connection types, such as a Mobile connection. The Home connection type may be preferred by the master user, for example, if the playlist is to be used primarily for parties at home. The Mobile connection type may be preferred by the master user, for example, when the playlist is primarily to be used with a group of friends on a road trip.

The generated playlist and its settings are registered and stored with a network server or an application server. The registration may include registering various types of data including, for example, a name of the playlist, a protocol associated with the playlist, a name of the application utilized for creating the playlist, a version name or number of the application utilized for creating the playlist, a user identification (ID) associated with the playlist, a device ID associated with the device (e.g., master device) requesting generation of the playlist, a network address (e.g., IP address) associated with the device requesting generation of the playlist, one or more settings associated with the playlist, and a date and time the playlist was generated. All or part of the registered data may be available to devices connected to the same network as the master device.

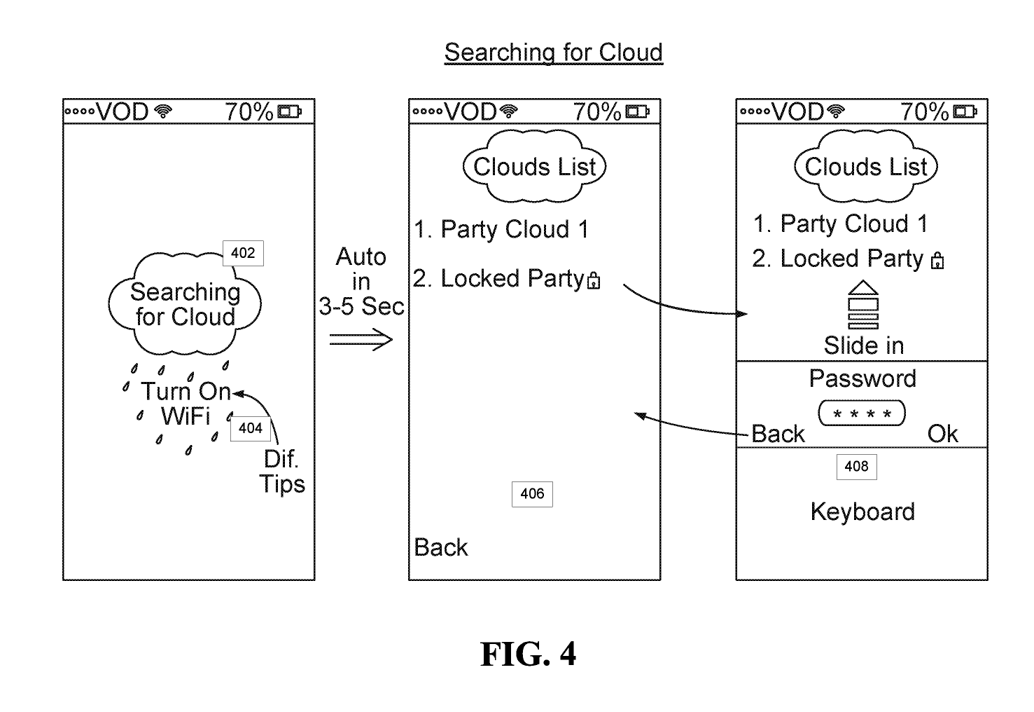

Referring back to FIG. 2, if the user selects an option to join a playlist (214), the master device may execute one or more operations to conduct a playlist search. Playlists may be searched for in various suitable databases, storage units, servers, or, as shown in FIG. 4, in cloud networks (402). While conducting the search, the master device may provide one or more tips to the master user (404), and upon completion of the search, may display the search results (406). The master device may then receive a selection from the master user of one of the displayed playlists, for example, the “Locked Party” playlist selected in FIG. 4. The tips presented to the master user (404) may include various types of tips including, but not limited to, tips for executing one or more functions in the playlist sharing application, tips on how to share the playlist with other users, and notices on activating certain functions, for example, Wi-Fi connection, to improve the playlist sharing experience of the master user.

In response to selection of the playlist by the master user, the representation of the selected playlist may be modified in various suitable ways. For example, in some implementations, an icon may be placed next to the selected playlist. In some implementations, the representation of the playlist may be highlighted or displayed in a different color. In addition, in response to selection of the playlist, the master device may determine whether the selected playlist has a password and may request the master user to enter the password if a password is required to join the playlist (408).

If the master user enters the wrong password, the master device does not provide access to the selected playlist and may output an incorrect password message for display to the user. If the master device verifies that the password entered is correct, the master device may display a graphical user interface through which the master user may interact with the playlist.

In some implementations, after joining a playlist, the master user may request the standing or current master of the joined playlist to be designated as the master of the joined playlist. The standing master may approve or reject the request. If the standing master approves the request, the master user may become the master of the joined playlist.

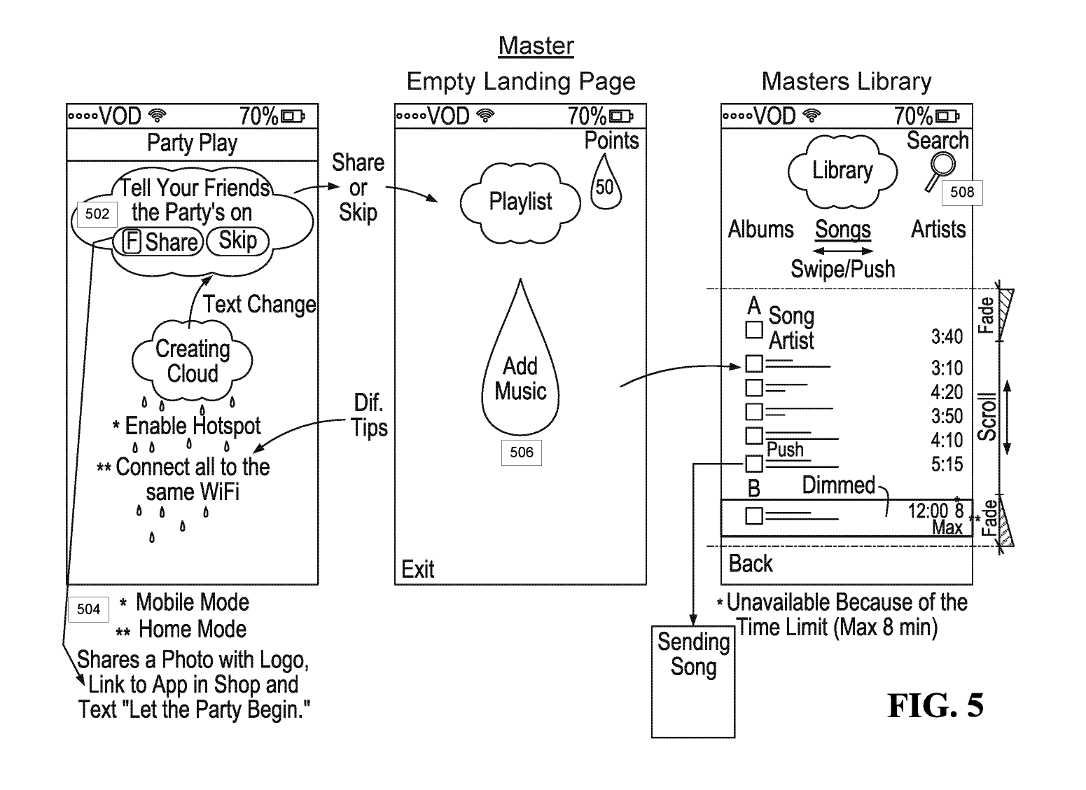

Referring back to FIG. 1, after creating a playlist, the master user may edit the playlist by adding songs to the playlist and share the creation of the playlist with other people (106). For example, referring to FIG. 5, after creating a playlist, the master device may present an option for the master user to share the creation of the playlist with one or more contacts in the master user's social network or to skip the sharing and add media files (502). If the master user selects the option to share the playlist with other users, the master device may open one or more social media interfaces, such as, for example, Facebook, Twitter, email, short media messaging (SMS), and compose a message with playlist information to be shared with the master user's social media network (504). The playlist information may include one or more of an image associated with the playlist, a name of the playlist, a link to download the playlist sharing application from an application store, and various additional information such as a name of the master user and a time of creation of the playlist. Although FIG. 5 depicts an option to share the playlist before media files are added to the playlist, the master user may share the playlist with other people at any time.

If the master user selects the option to skip the sharing and add media files to the playlist (506), the master device may access and display a media library accessible to the master user (508). The media library may be stored on the master device, on the network, or in a cloud account accessible to the master user. In some implementations, the one or more media files may be selected from an online media store or database. For example, the master user may be subscribed to a media provision or sharing service that can provide songs to the master device or library through the network. The master user may select one or more media files to add to the playlist from the media library. As described in further detail below, a media file selected for addition to a playlist is added to the playlist if the selected media file satisfies the settings and conditions for adding media files to the particular playlist.

In some implementations, if the master user is not subscribed to a media provision service, the master device may prompt the master user to subscribe to a media provision service. The master user may then select whether or not to subscribe to a media provision service. If the master user does not subscribe to a media provision service, a master device may display a message indicating that certain features of the playlist sharing application may not be available.

In some implementations, the master device may display selected files in the media library in a distinguishable manner from unselected media files. For example, a selected file may appear in one or more of a different color, size, font, background, and foreground compared to an unselected file. In some cases, a selected file may have an icon or tag displayed next to the file name to indicate the selection of the file.

In some implementations, one or more media files in the library may not be selectable by the master user. Media files that do not confirm to the settings of a playlist cannot be added to the playlist. For example, if the master user specified that a maximum media file length is 10 MB or 5 mins, then any media file that is greater than 10 MB or greater than 5 MB is not selectable by the master user.

Guest users and devices may also access the playlist created by the master user. The guest devices may connect to the same network the master device is connected to. For example, referring back to FIG. 1, in some implementations, a guest device may connect to a master device that operates as a hotspot for local devices to connect to (150). In some cases, a guest device may connect to the same WiFi network the master device is connected to.

After connecting to the same network as the master device, the guest device may search for playlists on the network (152). For example, the guest device may send a query for available playlists on the network to a network server or an application server. Upon receiving the query, the network or application server may communicate with a database that stores information, such as IP addresses, of the devices connected to the network and any playlists for which the devices are masters of. The network or application server may obtain data indicative of the playlists available on the network and transmit the obtained data to the guest device. The data indicative of the playlists available on the network may include various types on information including, for example, an IP address of a network device, a MAC address of the network device, a port address of the network device, a designated name of the network device, one or more playlist names for which the network device is a master of or a subscriber of, and themes or other content, e.g., a list of media files, associated with the respective available playlists. In some implementations, this playlist query and response process is also executed for the playlist search described with reference to FIG. 4.

The guest device receives and displays at least a portion of the data indicative of the playlists available on the network in response to the query for playlists (154). The guest user may then select one of the available playlists to join as a contributor to the playlist.

In some implementations, a request for joining the playlist as a contributor is sent to the master device from the guest device. The master user may approve or reject the request from the guest user for joining the playlist as a contributor. A rejection or approval message is transmitted from the master device to the guest device based on the master user's approval or rejection. The approval message may include a network address (e.g., IP address) of the master device that can be used by the guest device to communicate with the master device. In some cases, a resolving service may be implemented to resolve the request to join the playlist. The resolving service may determine if the request satisfies one or more rules and protocols associated with the playlist. If the resolving service determines that there are no conflicts, the guest user may be permitted to join the playlist as a contributor, and the approval message may be transmitted to the guest device.

In some implementations, a password may be required to join the playlist as a contributor. If a guest user would like to join a playlist as a contributor, the guest user may be prompted to enter a password after selecting a playlist. The password may be sent in the request to join the playlist. The master device or a playlist sharing application server may determine if the password received from the guest device is authentic. If the password is authentic, the master device may transmit an approval message to the guest device indicating that the guest user has successfully joined the playlist as a contributor, and the guest user is provided access to the playlist. In some cases, no approval message may be transmitted. If the password is not authentic, the master device may transmit a rejection message to the guest device indicating that the guest user has failed to join the playlist as a contributor.

In some implementations, no approval or authentication may be performed, and a guest user may automatically be added as a contributor to the playlist in response to selecting a playlist.

In some implementations, contributors to the playlist may be limited to a predetermined type of guest users. For example, a master user may limit the contributors to friends in a social network or may provide a list of individuals who are authorized to contribute.

In some implementations, upon creating or joining a playlist, the master user or guest user who joined a playlist may send one or more invitations to other people to join the playlist, as discussed above with reference to FIG. 5. The invitations may include a link for downloading an application for sharing the playlist, a link for accessing the playlist, and, in some cases, a password for accessing the playlist. Invited users may download the application if no playlist sharing application is available on their respective devices. If the respective devices include the playlist sharing application, the invited users may join the playlist as contributors by accessing the playlist using the link and password sent in the invitation.

After joining the playlist as a contributor, a guest device may receive information regarding the playlist and the master user. For example, the guest device may receive information indicating a subscription status of the master user with a media provision service. For instance, the guest device may be informed that master user is not subscribed to any media provision service or is subscribed to a particular provision service. A media provision service may include any service that provides access to media files. The guest device may also be provided information on the playlist settings of the playlist. As noted above, the playlist settings may include one or more of a number of users permitted to contribute to the playlist, a type and a number of media files in the playlist, a size limit on media files in the playlist, a time limit for playback of a media file in the playlist, and a type of network the playlist is provided through.

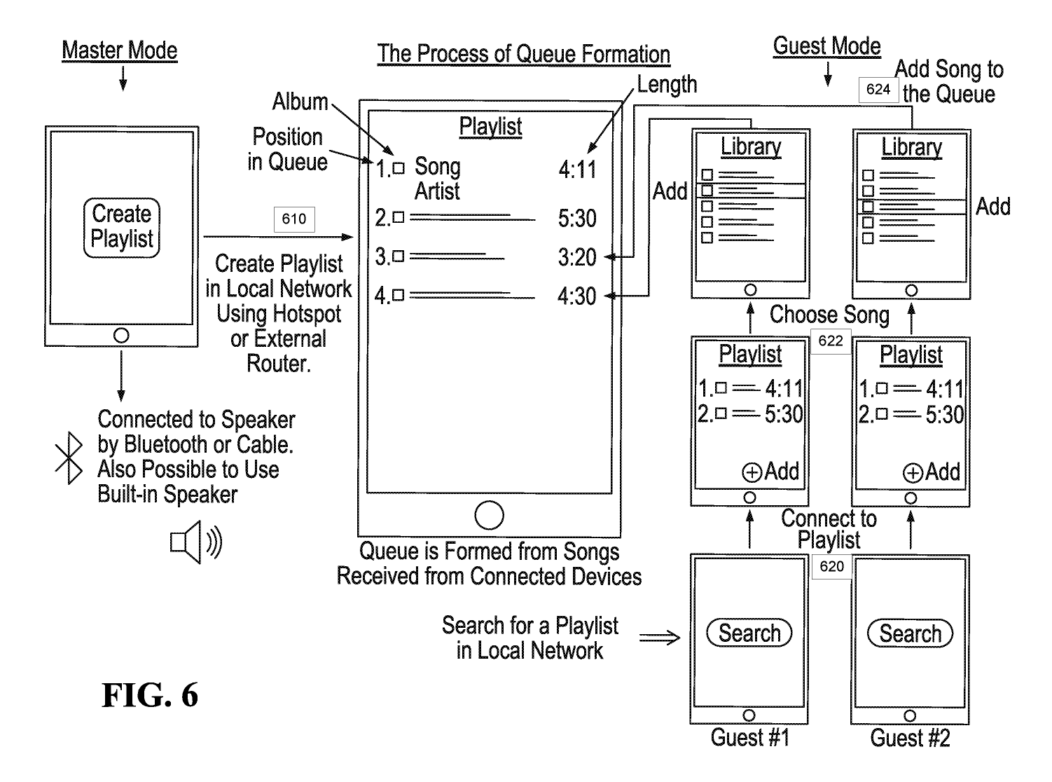

Referring to FIG. 6, after searching for and selecting a playlist as described above (152, 154, 620) a guest user may select an option to add one or more media files (622) to the playlist created by the master user (610). The one or more media files may be selected from a media library accessible to the master user (624). The media library may be stored on the guest device, on the network, or in a cloud account accessible to the guest user. In some implementations, the one or more medial files may be selected from an online media store or database.

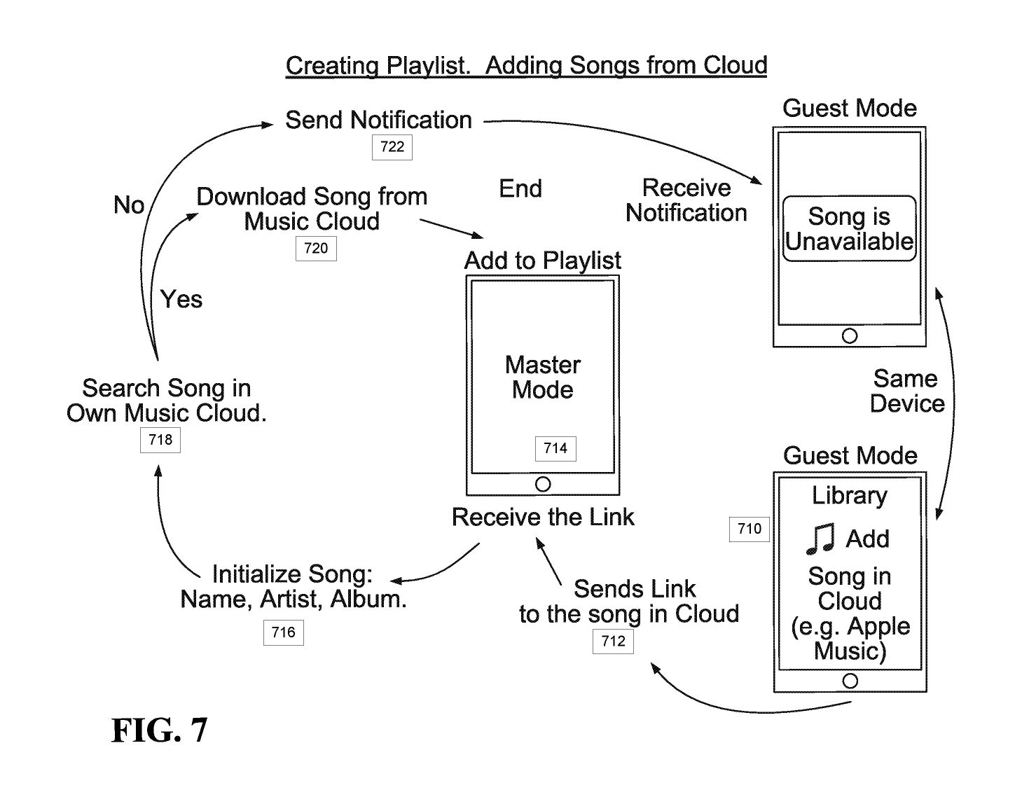

Referring to FIG. 7, after receiving a selection of a media file, the guest device may determine whether the selected media file satisfies a criteria for adding media files to the playlist (710). For example, in some cases, the guest device may determine whether the selected media file satisfies the settings, for example, the time and size limits of the media file, specified by the master user. As another example, the guest device may determine whether the selected media file corresponds to a theme associated with the playlist. As another example, the guest device may determine a number of instances the selected media file has already been listed in the playlist and allow the media file to be added if the threshold for repeated instances of the selected media file has not been reached. As another example, the guest device may determine if the limit for a number of consecutive media files added by a single user has been reached. If the limit has not been reached, the selected media file may be permitted to be added.

If the selected media file does not satisfy the criteria for adding media files to the playlist, the guest device may display a message to the guest user indicating that the file cannot be selected and may prompt the guest user to select another file. In some cases, the determination of whether the selected media file satisfies a criteria for adding media files to the playlist is conducted at the master device after the master device receives data indicative of the guest user's media file selection.

The guest device may also determine how to transmit data indicating the selection of the media file to the master device (712). For example, if the master user is subscribed to a media provision service, the guest user may obtain a link to a selected media file that provides access to the media file through the media provision service and transmit the link to the master device in response to a selection of a media file by the guest user. Sending a link instead of a media file helps provide faster communication between the guest and master devices, and also reduces network congestion. Accessing media files through media provision services also helps avoid digital rights issues or abuses.

In some implementations, if the master user is not subscribed to a media provision service, the guest device may determine if a selected media file is available in a local storage database or in a network media storage database accessible by the guest device. The guest device may then obtain a copy of the selected media file from the local or network media storage database and transmit the media file to the master device. In some cases, when the master user is not subscribed to a media provision service, the guest device may limit the files selectable by the guest user to media files that are stored in the guest device or can be transmitted from a storage database associated with the guest user to the master device. In some implementations, the guest device may output one or more messages to the guest user indicating that the master user is not subscribed to a media provision service, and requesting the guest user to select files that are accessible by the guest user.

In some implementations, if the guest user is subscribed to a media provision service, the guest device may present an option to the guest user to create a new playlist. If the guest user agrees to create a new playlist, a new playlist is created and users of the prior playlist the guest user was attempting to add a song to may receive invitations to join the new playlist with active media provision service. The newly-created playlist includes the same list of media files in the prior playlist the guest user was attempting to add a song to. The guest user may be designated as the master of the new playlist.

When a file is selected by the guest user through the playlist sharing application in the guest device, the guest device transmits data indicating the selected media file to be added to the playlist to the master device. The data indicative of the selected media file may include various types of data associated with the selected media file including, for example, a name and a method of accessing or downloading the media file. As noted above, if the master device is subscribed to a media provision service, the guest device transmits a link that provides access to the selected media file by the master device using the media provision service. If the master device is not subscribed to a media provision service, the guest device may transfer a copy of the selected medial file directly or indirectly from a storage database.

The master device receives the data indicative of the selected media file (714) and may then initialize the media file by, for example, determining metadata associated with the media file (716). The determined metadata may include various types of data including, but not limited to, a title of the media file, an artist associated with the media file, an album associated with the media file, and a creation or publication date associated with the media file. The metadata may be extracted from the data sent from the guest device to the master device or may be obtained from various other sources such as an online media library or database, and the Internet.

In some implementations when the master device is subscribed to a media provision service, the master device transmits a request to a media database that supports the media provision service (718). The request includes a query for the selected media file. The query may include information obtained from the link sent by the guest device, such as an address of the media database, a query format, and various other types of information for identifying and obtaining the selected media file from the media provision service. The media database may include various types of databases such as a cloud database and a virtual media store. The media database may search for the selected media file, and, upon locating a copy of the selected media file, may transmit the selected media file copy to the master device (720). The master device may then add the selected media file to the playlist and output the media file in accordance with the order of files listed in the playlist. If the media database cannot locate a copy of the selected media file, a message indicating that the selected media file could not be obtained is transmitted to one or more of the master device and the guest device (722).

In some implementations when the master device is not subscribed to a media provision service, the master device may obtain a copy from the guest device or a media database that does not require a subscription. For example, in some cases, if the selected media file is a video file that may be found on public platforms such as YouTube or Dailymotion, the master device may conduct a search using one or more of the public platforms to obtain a copy of the media file from YouTube or Dailymotion. In this process, the master device may perform any format or file conversions, if needed, to output the obtained media file through the playlist.

In some implementations, multiple users may be contributors in a playlist. In some implementations, the master user may limit the number of contributors in a playlist. In some implementations, the number of contributors in a playlist may be limited by network capacity or bandwidth. For example, the number of contributors in a WiFi or wireless local access network (WLAN) network may be greater than the number of contributors in a wide area network (WAN).

When a media file is added to a playlist, an update is transmitted to all guest devices and the master device that are contributing to the playlist. A GUI on each device may display the playlist, and controls and buttons associated with the playlist. For a particular user, a graphical indicator may be displayed next to each media file that the particular user has added to the playlist. In some cases, each user may be allocated a unique graphical indicator. The graphical indicator may be any suitable type of mark, graphic, sign, symbol, or badge. In some cases, the graphical indicator may be generated by an application server or the master device. In some cases, the graphical indicator may be generated by the guest device. For each user, the graphical indicator may be displayed next to each file added by the user.

In some implementations, only the particular user and the master user are authorized to delete or modify a position of a file that was added to the playlist by the particular user. The user who would like to modify a position of the user's file in the playlist may do so by selecting the graphical indicator. A prompt may then be displayed requesting the user to provide more details as to how the user would like to modify the position of the user's file. For example, in some cases, the user may indicate that the user would like to move the media file up the playlist by one position or to a particular position in the playlist. In some cases, the selection of the graphical indictor may automatically move the media file up the playlist by one position. In some implementations, as explained below, a user may modify the position of a media file only if the user has collected sufficient amount of in-app currency.

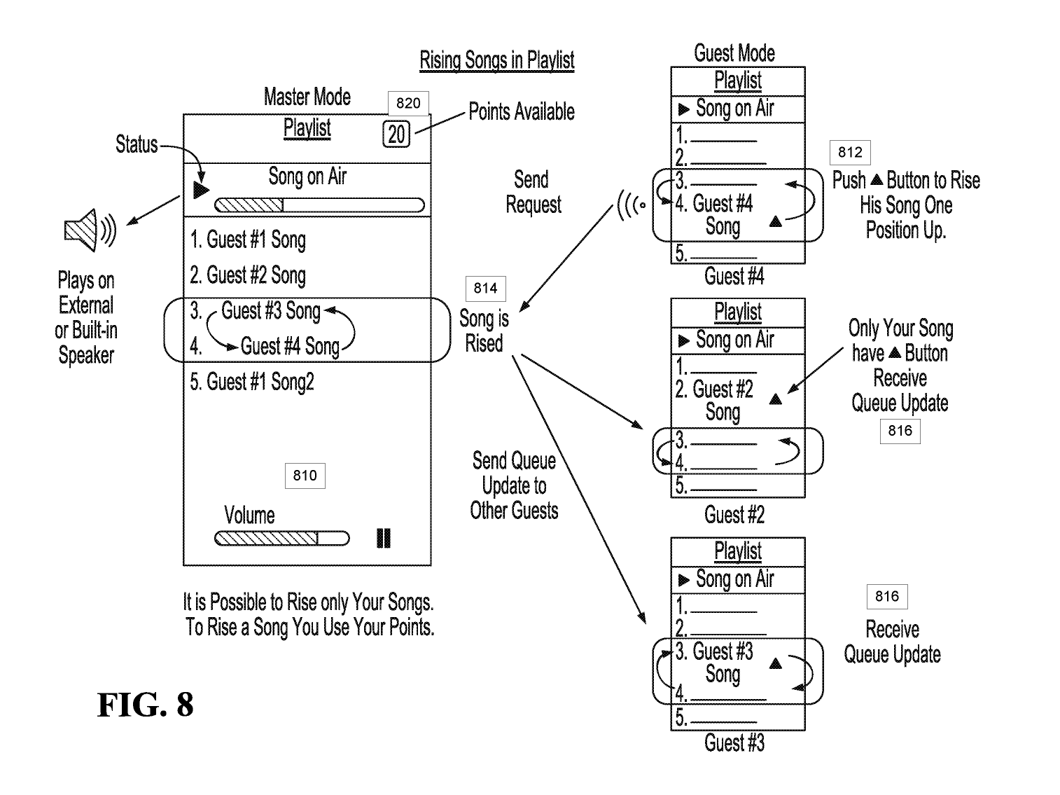

An example of playlist modification by a guest user is illustrated in FIG. 8. As shown in FIG. 8, a playlist generated by a master user may have five total songs from four different guests 810. Guest 1 has a song in the first and fifth position in the playlist. Guests 2, 3, and 4 have added songs in the second, third, and fourth positions in the playlist, respectively. When Guest 4 wants to modify the playlist, Guest 4 may only modify the position of the song in the fourth position because song 4 was added by Guest 4. Guest 4 may select a “Rise” button placed next to song number four in the playlist (812). A “Rise” button is a button which increases a position of a media file in the playlist. A “Fall” button is a button which decreases a position of a media file in the playlist. Here, an increase in the position means moving the media file to a position that requires less time for playback than the position currently occupied by the media file. For example, a user may select the “Rise” button to move a media file from the fourth position to the third position in the playlist.

In response to receiving Guest 4's selection to move song number four in the playlist (812), the song's position is adjusted in the master user's playlist (814) and a message is sent to the devices associated with guests 1 (not shown), 2, and 3 to update the playlist queue according to Guest 4's modification (816). In some implementations, the modification in the playlist is executed automatically without any approval. In some implementations, any modification in the playlist is executed only after receiving approval from the master user.

FIG. 8 also displays an exemplary user interface provided by the playlist sharing application 810. In addition to the playlist queue, the exemplary user interface may include volume controls, playback controls such as play, stop, fast forward, rewind, a media file output status, and a currency indicator 820. Although not shown, rise, fall, and delete controls may be provided and displayed on a user's playlist for each song that the user has added to the playlist.

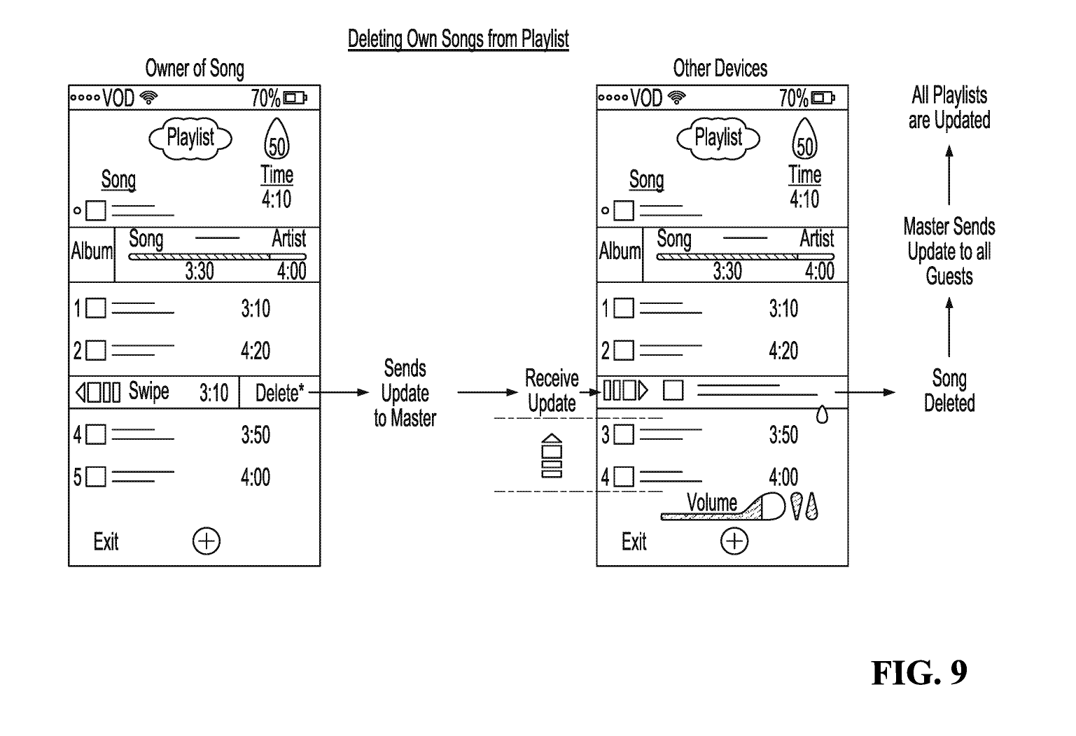

In some implementations, a user may select a graphical representation of a media file or a button associated with the media file to perform one or more operations. For example, the user's device may display control buttons such as a pause, fast forward, rewind, delete, move to the next filed, or move to the previous file control buttons. The user may then select one of the control buttons to perform a corresponding operation. For example, as shown in FIG. 9, the user device may delete a media file from the playlist in response to a user selection of the delete control button. In some implementations, the user may only modify a media file that has been added by the user to the playlist. In some implementations, a guest user and a master user may modify a media file that has been added by the guest user to the playlist. In some implementations, the user may select a microphone button to make an announcement to all the users that have contributed songs to a playlist. The announcement may be delivered in various suitable manners including by an audio output or by electronic messaging.

In some implementations, a currency allocation system may be implemented in which each user has an in-app currency account. For example, the currency indicator 820 in FIG. 8 indicates that the master user has 20 available currency points.

Users may be rewarded with currency points or a currency amount based on their use of the playlist sharing application. For example, users may be allocated various amounts of currency points for creating and sharing playlists, adding media files to a playlist, a length of time or frequency that a playlist of the user is played, or referring a number of other users that use the playlist sharing application. In some cases, currency points may be deducted from a user's in-app currency account for using certain features of the playlist sharing application. For example, a user may utilize the currency in the user's in-app currency account to delete or modify a position of a song added by the user to a playlist. Accordingly, the user's in-app currency account may be deducted by a number of currency points corresponding to a used feature. Thus, if the users in FIG. 8 were participating in the currency allocation system, Guest 4 may only be authorized to move song four if Guest 4 had sufficient currency points to modify a position of song four.

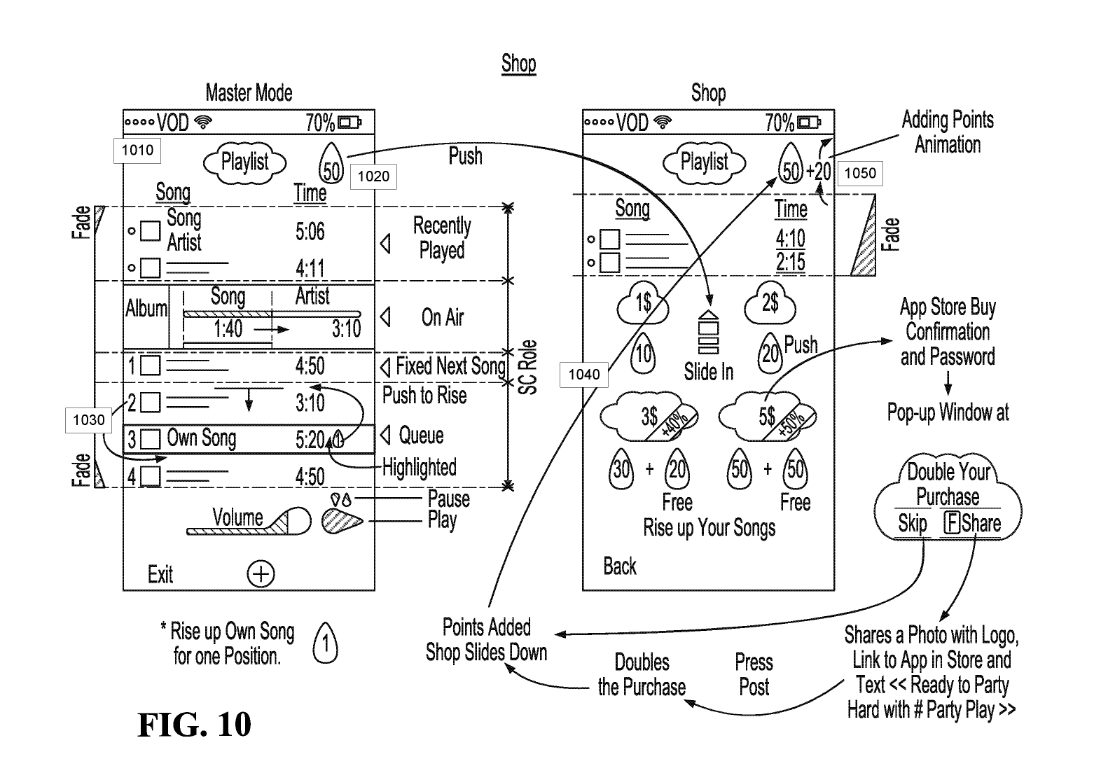

FIG. 10 illustrates another example of a use of an in-app currency account. In FIG. 10, a master device is displaying a playlist (1010). The displayed playlist may include songs that were recently played, a song that is currently being output, the song scheduled to be output next, and additional songs in the playlist queue. The playlist has four songs in the queue and the third song in the queue is a song that has been added by the master user. The master user also has 50 currency points (1020).

In some implementations, the playlist sharing application may assign a currency budget for one or more operations to be executed by users. For example, the playlist sharing application may have a budget for executing one or more of a “Rise” operation, a “Fall” operation, adding a song to the playlist, and, in general, any suitable operation designated by the playlist sharing application as having a currency budget associated with it. When the master user would like to increase a position of the master user's song, the master user may select the “Rise” button (1030). In response to selecting the “Rise” button, the master user's currency account may be deducted a currency amount corresponding to the budget for executing a “Rise” operation.

In some implementations, users may also shop for media using their in-app currency. For example, in response to receiving a selection of a graphical representation (1020) of the user's currency account, the master device may display a shopping interface (1040) through which the master user may purchase media files through a media provision service and add songs to the playlist. As shown in FIG. 10, the master user may be rewarded for purchasing and adding songs to the playlist. The reward may include, for example, currency points being added to the master user's currency account (1050).

It should be understood that different operations executed by the master user may have different currency budgets. Accordingly, a user's currency account may be adjusted, for example, by points being added or deducted from the account, differently based on the type of operation executed. As an example, in FIG. 10, the master user may be awarded more currency points for purchasing a more expensive media file.

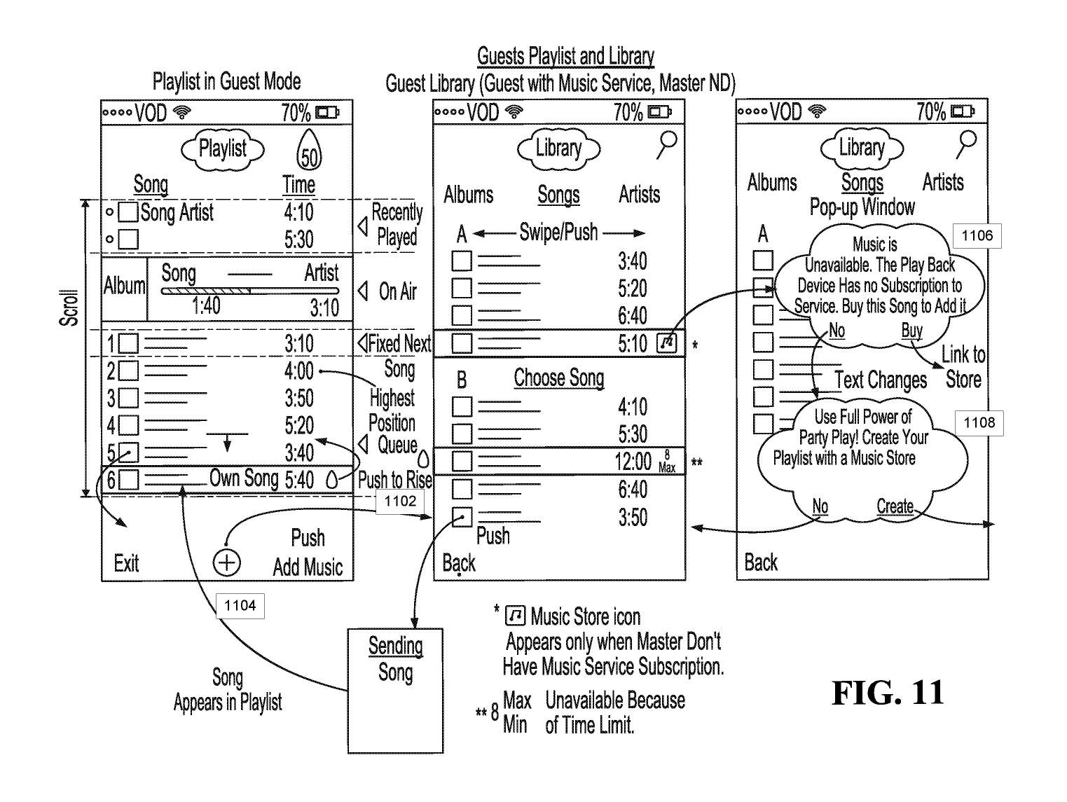

FIG. 11 depicts implementations in which a guest user browses a playlist and adds songs. As shown in FIG. 11, the guest user may have song in the sixth position in the playlist queue (1102). As described above, the guest user may select the “Rise” or “Fall” buttons to change a position of the guest user's song in the playlist queue. When the guest user makes a selection to add a media file to the playlist by selecting an Add File button (1104), the guest user's device displays the guest user's library.

The guest user's library may include a list of media files that the guest user has access to using various suitable sources such as a music provision service, a cloud database, or local or external networks, servers, and databases. The guest user's library may graphically indicate, using any suitable means, whether one or more media files are unavailable or ineligible to add to the playlist because the one or more media files fail to satisfy one or more conditions and settings of the playlist. For example, a song having a length of 12 minutes may be ineligible due to the media file length requirement of the playlist. Additionally, one or more media files may be unavailable if the master user does not have a subscription service to access the media file.

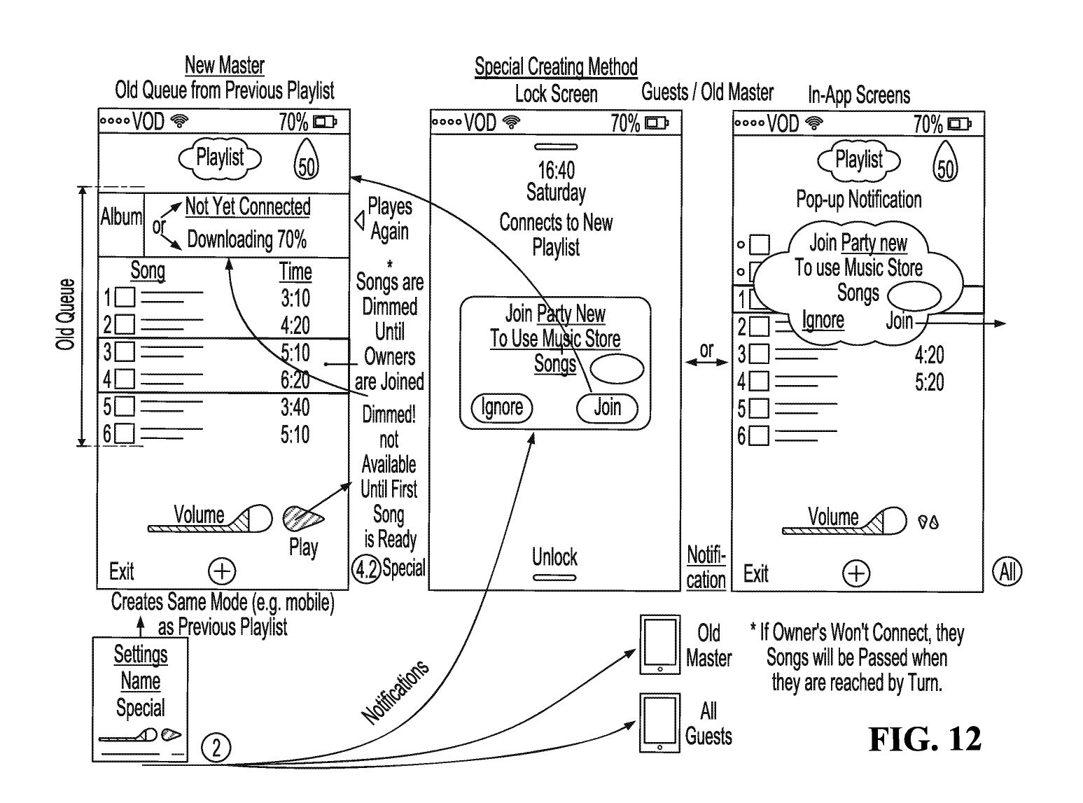

In some implementations, if the guest user selects one of the unavailable or ineligible media files, the guest user device may query the guest user (1106) as to whether the guest user is interested in purchasing the selected media file or creating another playlist in which the guest user may be able to configure different settings and use the guest user's media provision subscription service (1108). The process for a guest to create a new playlist and become a master is illustrated in FIG. 12. In some implementations, if a selected media file is unavailable because the master device does not have access to the selected media file or access to a subscription service, the guest user device may determine if a local copy of the selected medial file exists on the guest user device or a storage that the guest user device has access to. If a local copy does exist and can be obtained by the guest user device, the guest user device may query the guest user as to whether the guest user would like to transmit the selected media file to the master device. If the guest user chooses to transmit the selected media file, the guest user device obtains the selected media file and wirelessly transmits the file to the master device.

If the guest user is interested in creating another playlist (1108),

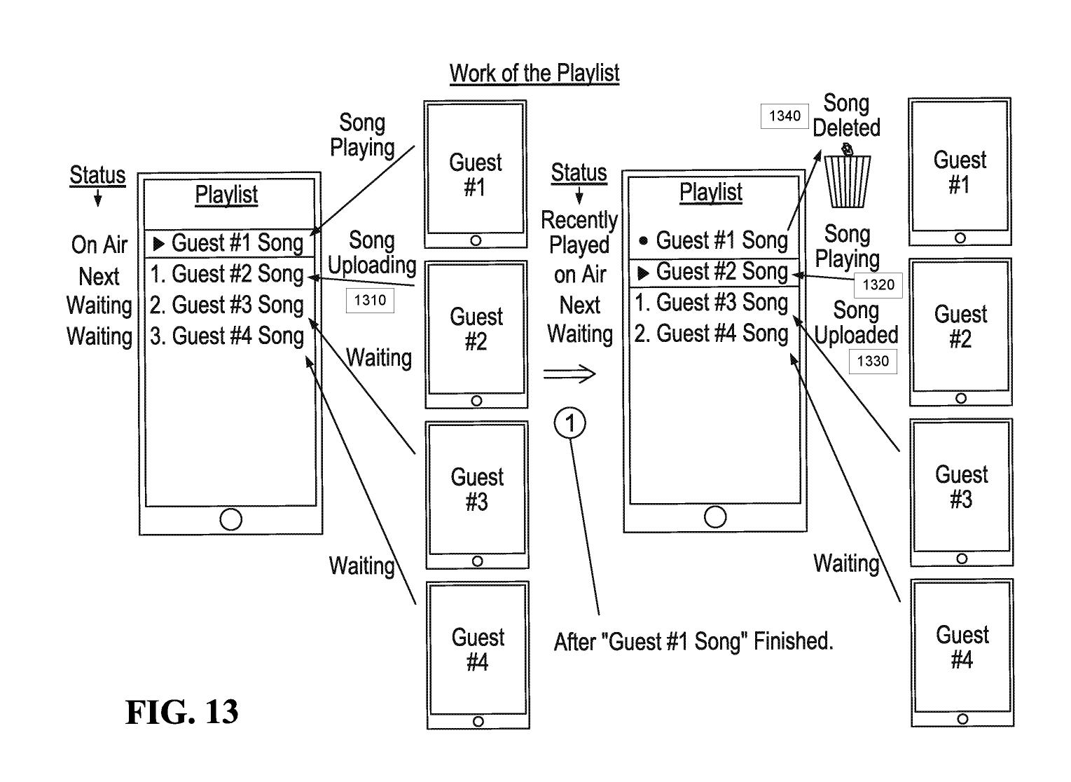

Additional features of the playlist sharing implementations are described in FIGS. 13, 14, and 15. Referring to FIG. 13, media files in a playlist may be obtained and output in a manner that reduces network load and increases network efficiency. For example, in some implementations, the master device may not upload all the media files in the playlist as they are being added to the playlist. As illustrated in FIG. 13, while the topmost song, referred to as song 1, in the playlist queue is being output, the third and fourth songs have not yet been uploaded to the master device. When playback of the topmost media file is initiated, the master device begins executing an operation to upload the media file that is in runner up or second position in the playlist queue (1310). When playback of the topmost media file is terminated, the master device begins outputting song two (1320) and uploading song three (1330). Song 1, or the previous topmost song, may be deleted from storage and the playlist queue (1340). In this manner, a network that the master device is connected to is efficiently utilized and not burdened if too many guest users join a playlist and add songs to the playlist.

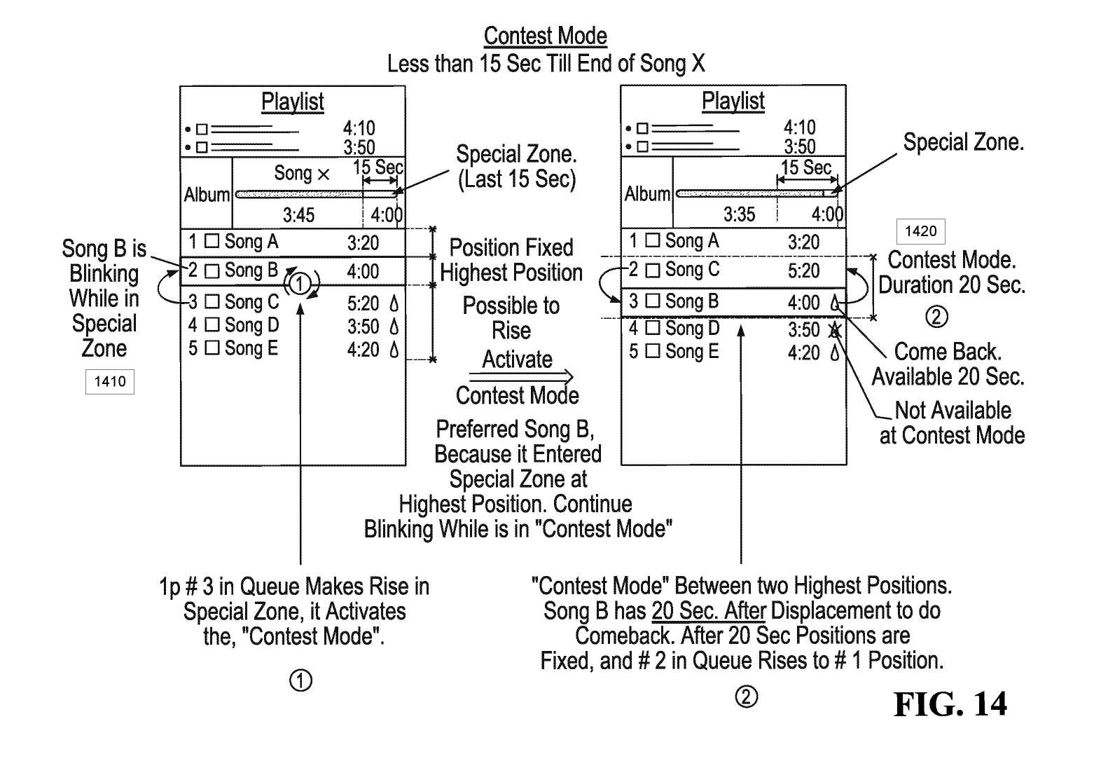

FIG. 14 depicts a contest mode of the playlist sharing application. In some implementations, when a media file is being output and is within a threshold time of the end of the media file output, a notification is generated indicating that the media file currently being output is about to terminate. The threshold time may be set by the master user of the playlist or may be set according to a default setting such as, for example, the last 15 seconds of a song. As shown in FIG. 14, when song X enters the last 15 seconds of its playback, song A, which is queued up next for output, has a fixed position. Songs B-E occupy the other positions in the playlist queue.

The generated notification indicating that the media file currently being output is about to terminate can be transmitted with different messages to different users. For example, the notification transmitted to users who added songs C-E may also indicate that they have a limited amount of time, for example, 15 seconds, if they would like their song to be the next song to be output after song A. Song B remains in a marked zone that is vulnerable to position modification in this contest mode and may be displayed in a different manner for the duration of the threshold time period. For example, the representation of song B may be displayed on and off in a blinking like manner or highlighted in a different color to indicate the vulnerability of song B during this threshold time period.

In the example illustrated in FIG. 14, the user who added song C may elect to increase the position of song C in the queue (1410). The playlist queue may then be modified so that song C occupies the second position and song B occupies the third position. The user who added song B is then given a second threshold period of time to respond to the position modification (1420). During the second threshold period of time, users who added songs B and C are locked in a contest, and other users, such as users who added songs D and E, cannot modify the position of their respective songs to be the next song to be output after song A. The second threshold time may be set by the master user of the playlist or may be set according to a default setting such as, for example, 20 seconds. After the second threshold time period expires, the last media file to occupy the marked zone moves into a fixed runners-up position (position previously occupied by song A) that cannot be changed.

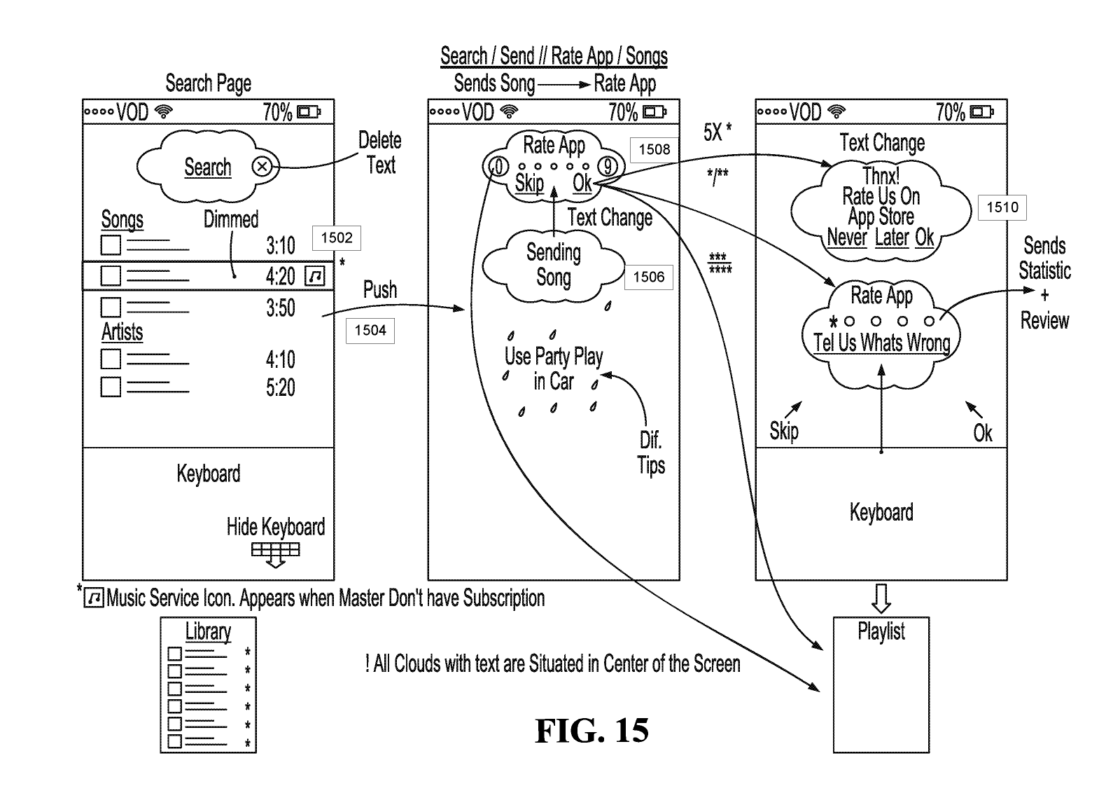

Referring to FIG. 15, the playlist sharing application may also include search assistance and rating features. For example, a user may search a library for media files to add to a playlist as described above. A search assistance feature provided by the playlist sharing application is that a graphical indicator may be displayed to indicate media files that the master user does not have access to through a music provision subscription service. Various suitable graphical indicators may be used including, but not limited to, a music service icon (1502), a different color, font, size of the representation(s) of the media file(s) that the master user does not have access to relative to files that the master user has access to. Accordingly, a user may have knowledge prior to selecting a media file as to whether the master user has access to a particular media file and is capable of outputting the media file.

In FIG. 15, after receiving a selection of a song on the search page (1504), the playlist sharing application may control the user device to display a message indicating that the selected song is being sent to the master device (1506). In some implementations, the user device may also display one or more tips, as described above, and an option for the user to rate the playlist sharing application (1508). If the user elects to rate the playlist sharing application, the user device displays a page in which the user may input information to rate the playlist sharing application (1510). If the user does not select the rating option, the user device may display the playlist queue or another home page.

Although some of the operations in the implementations described above are performed at the master device, the same operations may be performed by an application server on the network. For example, the application server may receive requests to create a playlist from a master device, or may receive requests to add files from guest devices, and may perform corresponding operations as described above. In some implementations, the application server may communicate with a media database to obtain a copy of a media file selected by a guest user or master user. In some implementations, the application server may control one or more of the order manipulation, addition, or deletion of files listed in the playlist. The application server may manage multiple playlists and may manage communication between multiple user devices for a particular playlist.

In addition, the above-described operations performed on the master device or guest user device may be performed using a playlist sharing application that can be installed on the master and guest devices using various suitable methods.

It should also be understood that although certain controls and buttons have been described as being implemented in a particular manner in the described implementations, variations of these controls and buttons may be used and applied. For example, instead of using rise and fall buttons, the user may execute a drag and drop command through a touch screen to execute a rise or fall operation.

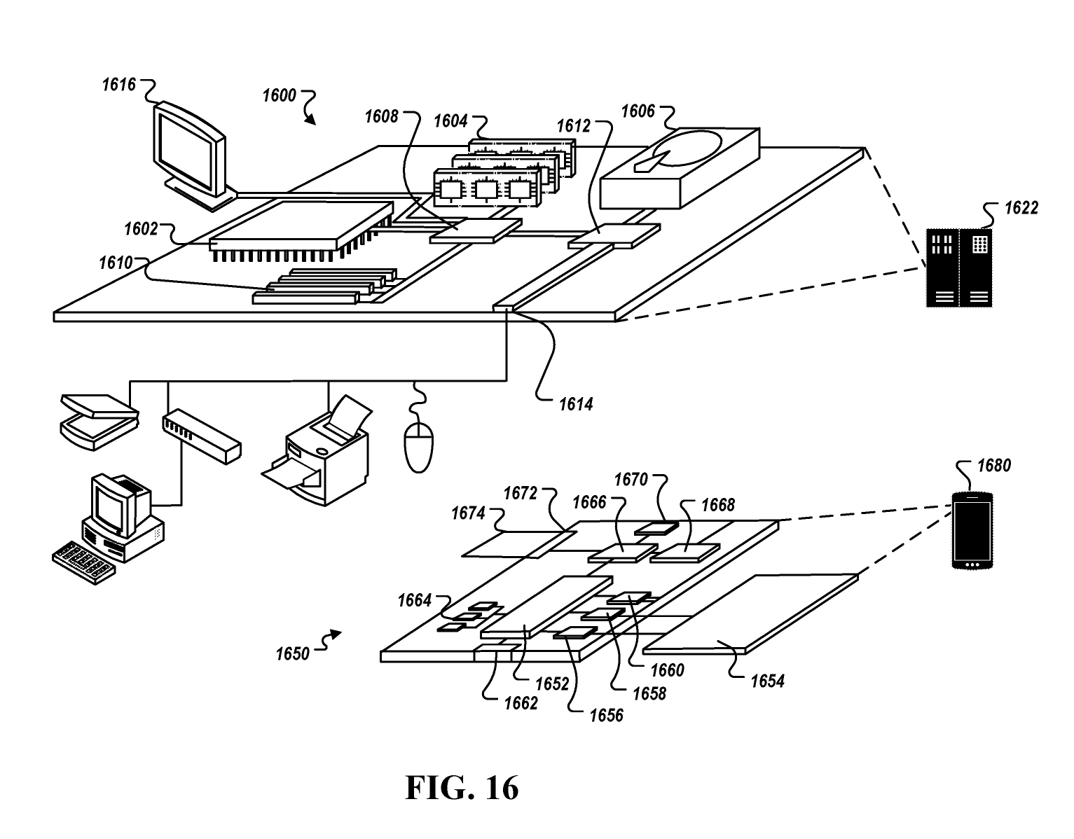

Embodiments and all of the functional operations and/or actions described in this specification may be implemented in digital electronic circuitry, or in computer software, firmware, or hardware, including the structures disclosed in this specification and their structural equivalents, or in combinations of one or more of them. FIG. 16 is a block diagram of computing devices 1600, 1650 that may be used to implement the systems and methods described herein. Computing device 1600 may represent various forms of digital computers, such as laptops, desktops, workstations, personal digital assistants, servers, blade servers, mainframes, and other appropriate computers. Computing device 1650 represents various forms of user devices, such as personal digital assistants, cellular telephones, smartphones, and other similar computing devices. The components shown here, their connections and relationships, and their functions, are exemplary, and do not limit implementations described herein.

Computing device 1600 includes a processor 1602, memory 1604, a storage device 1606, a high-speed interface 1608 connecting to memory 1604 and high-speed expansion ports 1610, and a low speed interface 1612 connecting to low speed bus 1614 and storage device 1606. Each of the components 1602, 1604, 1606, 1608, 1610, and 1612, are interconnected using various busses, and may be mounted on a common motherboard or in other manners as appropriate. The processor 1602 can process instructions for execution within the computing device 1600, including instructions stored in the memory 1604 or on the storage device 1606 to display graphical information for a GUI on an external input/output device, such as display 1616 coupled to high speed interface 1608. In some implementations, multiple processors and/or multiple buses may be used, as appropriate, along with multiple memories and types of memory. Also, multiple computing devices 1600 may be connected, with each device providing portions of the necessary operations (e.g., as a server bank, a group of blade servers, or a multi-processor system).

The memory 1604 stores information within the computing device 1600. In some implementations, the memory 1604 may include one or more of a computer-readable medium, a volatile memory unit(s), or a non-volatile memory unit(s).

The storage device 1606 is capable of providing mass storage for the computing device 1600. In some implementations, the storage device 1606 includes a computer-readable medium. In some implementations, the storage device 1606 may be a floppy disk device, a hard disk device, an optical disk device, or a tape device, a flash memory or other similar solid state memory device, or an array of devices, including devices in a storage area network or other configurations. In some implementations, a computer program product is tangibly embodied in an information carrier. The computer program product contains instructions that, when executed, perform one or more methods, such as those described above. The information carrier is a computer- or machine-readable medium, such as the memory 1604, the storage device 1606, or memory on processor 1602.

The high speed controller 1608 manages bandwidth-intensive operations for the computing device 1600, while the low speed controller 1612 manages lower bandwidth-intensive operations. Such allocation of duties is exemplary only. In some implementations, the high-speed controller 1608 is coupled to memory 1604, display 1616 (e.g., through a graphics processor or accelerator), and to high-speed expansion ports 1610, which may accept various expansion cards (not shown). In some implementations, a low-speed controller 1612 is coupled to storage device 1606 and low-speed expansion port 1614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1600 may be implemented in a number of different forms, as shown in the figure. For example, computing device 1600 may be implemented as a standard server 1622, a group of such servers, or as part of a rack server system. The server 1622 may be, for example, one or more of a network server, a playlist sharing application server, a content server, a playlist management server. In some implementations, the computing device 1600 may be implemented as a personal computer such as a laptop computer.

In some implementations, the computing device 1600 may wirelessly communicate with device 1650 over a network to execute one or more operations of the playlist sharing application. In some implementations, components from computing device 1600 may be combined with other components in device 1650.

The one or more networks may include access points, storage systems, cloud systems, modules, one or more databases including one or more media databases, and servers including one or more network servers such as computing device 1600. The one or more network servers may include any suitable computing device coupled to the one or more networks, including but not limited to a personal computer, a server computer, a series of server computers, a mini computer, and a mainframe computer, or combinations thereof. The one or more network servers may also include an application server, a web server, or a series of servers, running a network operating system, examples of which may include but are not limited to Microsoft® Windows® Server, Novell® NetWare®, or Linux®. The one or more network servers may be used for and/or provide cloud and/or network computing and media provision services. Although not shown in the figures, the server may have connections to external systems providing messaging functionality such as e-mail, SMS messaging, text messaging, and other functionalities, such as advertising services, search services, etc.

In some implementations, the one or more networks may include a cloud system that may provide Internet connectivity and other network-related functions. For example, the cloud system may provide storage services for at least a portion of the data transmitted between components of the system.

The system may also include a one or more databases, which may include a media storage database, a media provision database, a cloud database, or a database managed by a database management system (DBMS). A DBMS may be implemented as an engine that controls organization, storage, management, and retrieval of data in a database. DBMSs frequently provide the ability to query, backup and replicate data, enforce rules, provide security, do computation, perform change and access logging, and automate optimization. A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. Data structures can include fields, records, files, objects, and any other applicable known or convenient structures for storing data. A DBMS may also include metadata about the data that is stored.

Computing device 1650 may include a processor 1652, memory 1664, an input/output device such as a display 1654, a communication interface 1666, and a transceiver 1668, among other components. The device 1650 may also be provided with a storage device, such as a microdrive or other device, to provide additional storage. Each of the components 1650, 1652, 1664, 1654, 1666, and 1668, may be interconnected using various buses, and several of the components may be mounted on a common motherboard or in other manners as appropriate.

The memory 1664 stores information within the computing device 1650. In some implementations, the memory 1664 includes a computer-readable medium or sores one or more modules of computer program instructions encoded on a computer readable medium for execution by, or to control the operation of, data processing apparatus. The computer-readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, for example, code that constitutes processor firmware, a protocol stack, a database management system, an operating system, or a combination of one or more of them. A propagated signal is an artificially generated signal, for example, a machine-generated electrical, optical, or electromagnetic signal that is generated to encode information for transmission to suitable receiver apparatus.

A computer program, also known as a program, software, software application, script, plug-in, or code, may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data in a single file dedicated to the program in question, or in multiple coordinated files. A computer program may be deployed to be executed on one computer or on multiple computers that are located at one site or distributed across multiple sites and interconnected by a communication network.

In some implementations, the memory 1664 is a volatile memory unit or units. In some implementations, the memory 1664 is a non-volatile memory unit or units. Expansion memory 1674 may also be provided and connected to device 1650 through expansion interface 1672, which may include, for example, a SIMM card interface. Such expansion memory 1674 may provide extra storage space for device 1650, or may also store applications or other information for device 1650. Specifically, expansion memory 1674 may include instructions to carry out or supplement the processes described above, and may include secure information also. Thus, for example, expansion memory 1674 may be provide as a security module for device 1650, and may be programmed with instructions that permit secure use of device 1650. In addition, secure applications may be provided via the SIMM cards, along with additional information, such as placing identifying information on the SIMM card in a non-hackable manner.

The memory may include for example, flash memory and/or MRAM memory, as discussed below. In some implementations, a computer program product is tangibly embodied in an information carrier. The computer program product contains instructions that, when executed, perform one or more methods, such as those described above. The information carrier is a computer- or machine-readable medium, such as the memory 1664, expansion memory 1674, or memory on processor 1652.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, for example, an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor may receive instructions and data from a read only memory or a random access memory or both.

Device 1650 may communicate wirelessly through communication interface 1666, which may include digital signal processing circuitry where necessary. Communication interface 1666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1668. In addition, short-range communication may occur, such as using a Bluetooth, WiFi, or other such transceiver (not shown). In addition, GPS receiver module 1670 may provide additional wireless data to device 1650, which may be used as appropriate by applications running on device 1650.

Device 1650 may also communication audibly using audio codec 1660, which may receive spoken information from a user and convert it to usable digital information. Audio codex 1660 may likewise generate audible sound for a user, such as through a speaker, e.g., in a handset of device 1650. Such sound may include sound from voice telephone calls, may include recorded sound (e.g., voice messages, music files, etc.) and may also include sound generated by applications operating on device 1650.

The processor 1652 can process instructions for execution within the computing device 1650, including instructions stored in the memory 1664. The processor may also include separate analog and digital processors. The processor may provide, for example, for coordination of the other components of the device 1650, such as control of user interfaces, applications run by device 1650, and wireless communication by device 1650.

Processor 1652 may communicate with a user through control interface 1658 and display interface 1656 coupled to a display 1654. The display 1654 may be, for example, a TFT LCD display or an OLED display, or other appropriate display technology. The display interface 1656 may comprise appropriate circuitry for driving the display 1654 to present graphical and other information to a user. The control interface 1658 may receive commands from a user and convert them for submission to the processor 1652. In addition, an external interface 1662 may be provide in communication with processor 1652, so as to enable near area communication of device 1650 with other devices. External interface 1662 may provide, for example, for wired communication (e.g., via a docking procedure) or for wireless communication (e.g., via Bluetooth or other such technologies).

The computing device 1650 may be implemented in a number of different forms, as shown in the figure. For example, computing device 1650 may be implemented as a cellular telephone 1680, a smartphone, personal digital assistant, or other similar electronic device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Various types of displays such as touch-screens, resistive displays, or capacitive displays may be used. Other kinds of devices can be used to provide for interaction with a user as well; for example, feedback provided to the user can be any form of sensory feedback (e.g., visual feedback, auditory feedback, haptic feedback, or tactile feedback); and input from the user can be received in any form, including acoustic, speech, or tactile input.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and may even be claimed as such, one or more features from a claimed combination may in some cases be excised from the combination, and the claimed combination may be directed to a sub-combination or variation of a sub-combination.

Similarly, while actions are depicted in the drawings in a particular order, this should not be understood as requiring that such actions be performed in the particular order shown or in sequential order, or that all illustrated actions be performed, to achieve desirable results. Moreover, the separation of various system components in the embodiments described above should not be understood as requiring such separation in all embodiments, and it should be understood that the described program components and systems may generally be integrated together in a single software product or packaged into multiple software products.

It should be understood that the phrase one or more of and the phrase at least one of include any combination of elements. For example, the phrase one or more of A and B includes A, B, or both A and B. Similarly, the phrase at least one of A and B includes A, B, or both A and B.

Thus, particular implementations have been described. Other implementations are within the scope of the following claims. For example, the actions recited in the claims may be performed in a different order and still achieve desirable results.

What is claimed is:

1. A computer-implemented method comprising:
receiving, from a second user device, a request to access a playlist created by a first user device, the first user device and the second user device being connected to the same wireless network;
providing, to the second user device, (i) access to the playlist created by the first user device, and (ii) an indication of a subscription status of a user associated with the first user device with a media provision service;
receiving, from the second user device, an indication of a media file to be added to the playlist;
determining, by one or more processors, metadata associated with the media file to be added to the playlist based on the indication of the media file;
transmitting a query for the media file to a cloud database that supports the media provision service using portions of the metadata associated with the media file;
obtaining, from the cloud database, the media file; and
adding the media file to the playlist.

2. The computer-implemented method of claim 1, further comprising:
receiving a request to create the playlist from the first user device; and
responsive to the request to create the playlist, providing, to the first user device, data to generate and populate the playlist on the first user device.

3. The computer-implemented method of claim 1, further comprising:
receiving one or more playlist setting parameters to configure the playlist, the one or more playlist setting parameters comprising a number of users permitted to contribute to the playlist, a type and a number of media files in the playlist, a number of media files that are provided from one user and are listed consecutively in the playlist, a number of times the same media file is repeated in the playlist, a size limit on media files in the playlist, a time limit for playback of a media file in the playlist, and a type of network the playlist is provided through.

4. The computer-implemented method of claim 1, wherein providing, to the second user device, access to the playlist created by the first user device comprises:
responsive to receiving, from the second user device, the request to access the playlist created by the first user device, determining whether a user associated with the second user device is authorized to join the playlist as a playlist contributor;
determining that the second user device is authorized to join the playlist as a playlist contributor; and
transmitting, to the second user device, a message indicating that the user associated with the second user device is authorized to join the playlist as a playlist contributor.

5. The computer-implemented method of claim 1, further comprising;
receiving, from the second user device, a query for one or more playlists available on the network;
determining one or more network addresses of one or more network devices, respectively, and one or more playlists provided by the one or more network devices;
transmitting, to the second user device, data indicative of the one or more playlists available on the network, the data indicative of the one or more playlists available on the network comprising data indicative of the determined one or more playlists provided by the one or more network devices; and
receiving, from the second user device, a selection of one of the one or more playlists available on the network, the selected playlist corresponding to the playlist created by the first user device.

6. The computer-implemented method of claim 1, wherein the metadata associated with the media file to be added to the playlist is determined when the user associated with the first user device is subscribed with the media provision service.

7. The computer-implemented method of claim 1, further comprising:
in response to receiving, from the second user device, the indication of the media file to be added to the playlist:
determining that the media file satisfies a criteria for being added to the playlist, the criteria comprising one or more of a size of the media file, a playback time of the media file, a theme associated with the playlist, a threshold for a number of media files that are provided from the second user device and listed consecutively in the playlist, and a number of times the media file is repeated in the playlist.

8. The computer-implemented method of claim 1, further comprising:
receiving, from the second user device, a request to modify a position of the added file in the playlist created by the first user device;
accessing a user profile of a user associated with the second user device;
determining, from data stored in the user profile of the user associated with the second user device, a currency amount allocated to the user associated with the second user device; and
determining whether the currency amount allocated to the user associated with the second user device satisfies a currency threshold for modifying the position of the added file.

9. The computer-implemented method of claim 8, further comprising:
responsive to determining that the currency amount allocated to the user associated with the second user device satisfies the currency threshold for modifying the position of the added file, modifying the position of the added file to a position indicated in the request to modify the position of the added file; or
responsive to determining that the currency amount allocated to the user associated with the second user device does not satisfy the currency threshold for modifying the position of the added file, transmitting, to the second user device, a message indicating that the position of the added file has not been modified.

10. The computer-implemented method of claim 1, further comprising:
receiving, from the second user device, a request to delete the added file from the playlist created by the first user device; and
removing the added file from the playlist created by the first user device.

11. The computer-implemented method of claim 1, further comprising:
for each user device having access to the playlist:
generating a graphical indicator for the user device;
providing the graphical indicator to the user device, the graphical indicator being displayed on the user device with a name of a file added by the user device to the playlist; and
receiving, through the graphical indicator, a selection to modify a position of the file added by the user device.

12. A non-transitory computer-readable storage medium comprising instructions, which, when executed by one or more processors, cause the one or more computers to perform operations comprising:
receiving, from a second user device, a request to access a playlist created by a first user device, the first user device and the second user device being connected to the same wireless network;
providing, to the second user device, (i) access to the playlist created by the first user device, and (ii) an indication of a subscription status of a user associated with the first user device with a media provision service;
receiving, from the second user device, an indication of a media file to be added to the playlist;
determining metadata associated with the media file to be added to the playlist based on the indication of the media file;
transmitting a query for the media file to a cloud database that supports the media provision service using portions of the metadata associated with the media file;
obtaining, from the cloud database, the media file; and
adding the media file to the playlist.

13. The non-transitory computer-readable storage medium of claim 12, wherein the operations further comprise:
receiving, from the second user device, a query for one or more playlists available on the network;
determining one or more network addresses of one or more network devices, respectively, and one or more playlists provided by the one or more network devices;
transmitting, to the second user device, data indicative of the one or more playlists available on the network, the data indicative of the one or more playlists available on the network comprising data indicative of the determined one or more playlists provided by the one or more network devices; and
receiving, from the second user device, a selection of one of the one or more playlists available on the network, the selected playlist corresponding to the playlist created by the first user device.

14. The non-transitory computer-readable storage medium of claim 12, wherein the operations further comprise:
receiving, from the second user device, a request to modify a position of the added file in the playlist created by the first user device;
accessing a user profile of a user associated with the second user device;
determining, from data stored in the user profile of the user associated with the second user device, a currency amount allocated to the user associated with the second user device; and
determining whether the currency amount allocated to the user associated with the second user device satisfies a currency threshold for modifying the position of the added file.

15. The non-transitory computer-readable storage medium of claim 14, wherein the operations further comprise:
responsive to determining that the currency amount allocated to the user associated with the second user device satisfies the currency threshold for modifying the position of the added file, modifying the position of the added file to a position indicated in the request to modify the position of the added file; or
responsive to determining that the currency amount allocated to the user associated with the second user device does not satisfy the currency threshold for modifying the position of the added file, transmitting, to the second user device, a message indicating that the position of the added file has not been modified.

16. A system comprising:
one or more processors and one or more storage devices storing instructions that are operable and when executed by the one or more processors, cause the one or more processors to perform operations comprising:
receiving, from a second user device, a request to access a playlist created by a first user device, the first user device and the second user device being connected to the same wireless network;
providing, to the second user device, (i) access to the playlist created by the first user device, and (ii) an indication of a subscription status of a user associated with the first user device with a media provision service;
receiving, from the second user device, an indication of a media file to be added to the playlist;
determining metadata associated with the media file to be added to the playlist based on the indication of the media file;
transmitting a query for the media file to a cloud database that supports the media provision service using portions of the metadata associated with the media file;
obtaining, from the cloud database, the media file; and
adding the media file to the playlist.

17. The system of claim 16, wherein the operations further comprise:
receiving, from the second user device, a query for one or more playlists available on the network;
determining one or more network addresses of one or more network devices, respectively, and one or more playlists provided by the one or more network devices;
transmitting, to the second user device, data indicative of the one or more playlists available on the network, the data indicative of the one or more playlists available on the network comprising data indicative of the determined one or more playlists provided by the one or more network devices; and
receiving, from the second user device, a selection of one of the one or more playlists available on the network, the selected playlist corresponding to the playlist created by the first user device.

18. The system of claim 16, wherein the operations further comprise:
receiving, from the second user device, a request to modify a position of the added file in the playlist created by the first user device;
accessing a user profile of a user associated with the second user device;
determining, from data stored in the user profile of the user associated with the second user device, a number of currency amount allocated to the user associated with the second user device; and
determining whether the currency amount allocated to the user associated with the second user device satisfies a currency threshold for modifying the position of the added file.

19. The system of claim 18, wherein the operations further comprise:
responsive to determining that the currency amount allocated to the user associated with the second user device satisfies the currency threshold for modifying the position of the added file, modifying the position of the added file to a position indicated in the request to modify the position of the added file; or
responsive to determining that the currency amount allocated to the user associated with the second user device does not satisfy the currency threshold for modifying the position of the added file, transmitting, to the second user device, a message indicating that the position of the added file has not been modified.

20. The system of claim 16, wherein the operations further comprise:
for each user device having access to the playlist:
generating a graphical indicator for the user device;
providing the graphical indicator to the user device, the graphical indicator being displayed on the user device with a name of a file added by the user device to the playlist; and
receiving, through the graphical indicator, a selection to modify a position of the file added by the user device.
